(19) United States
(12) Patent Application Publication
(10) Pub. No.: US 2022/0147533 A1
(43) Pub. Date: May 12, 2022

(54) SYSTEMS AND METHODS FOR AUTOMATED IMPORTANCE RANKING OF COMPUTING ELEMENTS

(71) Applicant: Cyber Reconnaissance, Inc., Tempe, AZ (US)

(72) Inventors: Paulo Shakarian, Tempe, AZ (US); Jana Shakarian, Tempe, AZ (US); Chandra Mohan, Tempe, AZ (US)

(21) Appl. No.: 17/523,653

(22) Filed: Nov. 10, 2021

Related U.S. Application Data
(60) Provisional application No. 63/111,890, filed on Nov. 10, 2020.

(51) Int. Cl. G06F 16/2457; G06F 16/901; G06F 21/57

(52) U.S. Cl. CPC G06F 16/24578; G06F 2221/034; G06F 21/57; G06F 16/9024

(57) ABSTRACT

Embodiments of a computer-implemented system and methods for automated ranking of computer element/asset importance are disclosed.

### CROSS REFERENCE TO RELATED APPLICATIONS

This is a U.S. Non-Provisional patent application that claims benefit to U.S. provisional patent application Ser. No. 63/111,890 filed on Nov. 10, 2020, which is herein incorporated by reference in its entirety.

### FIELD

The present disclosure generally relates to predictive cyber technologies; and in particular to systems and methods for automated generation of computing device importance rankings that improve and optimize cyber threat defense measures.

### BACKGROUND

An increasing number of software (and hardware) vulnerabilities are discovered and publicly disclosed every year. In 2016 alone, more than 10,000 vulnerability identifiers were assigned and at least 6,000 were publicly disclosed by the National Institute of Standards and Technology (NIST). Once the vulnerabilities are disclosed publicly, the likelihood of those vulnerabilities being exploited increases. With limited resources, organizations often look to prioritize which vulnerabilities to patch by assessing the impact it will have on the organization if exploited. Standard risk assessment systems such as Common Vulnerability Scoring System (CVSS), Microsoft Exploitability Index, Adobe Priority Rating report many vulnerabilities as severe and will be exploited to err on the side of caution. This does not alleviate the problem much since the majority of the flagged vulnerabilities will not be attacked.

NIST provides the National Vulnerability Database (NVD) which comprises of a comprehensive list of vulnerabilities disclosed, but only a small fraction of those vulnerabilities (less than 3%) are found to be exploited in the wild—a result confirmed in the present disclosure. Further, it has been found that the CVSS score provided by NIST is not an effective predictor of vulnerabilities being exploited.

It is with these observations in mind, among others, that various aspects of the present disclosure were conceived and developed.

### BRIEF DESCRIPTION OF THE DRAWINGS

The application file contains at least one photograph executed in color. Copies of this patent application publication with color photographs will be provided by the Office upon request and payment of the necessary fee.

FIG. 1A is a simplified block diagram of a computer-implemented system for automated computer device/asset importance ranking.

FIG. 1B is a simplified block diagram illustrating further aspects and an example embodiment of the system of FIG. 1A.

FIG. 2 is a simplified block diagram illustrating data flow for creating a multi-modal graphical representation of interactions between computing elements associated with a network or IT environment.

FIG. 3 is an exemplary multi-modal graph illustrating interaction and relationships among the plurality of computing elements (e.g., systems) of FIG. 1A which may be generated using the functionality depicted in FIG. 2.

FIG. 4 is a simplified block diagram of a graphical analysis processor for computing a ranking of computing element importance from the graph results of FIG. 3.

FIG. 5 is an illustration of exemplary ranking of computer elements following the example of FIGS. 3-4 using degree centrality.

FIG. 6 is a simplified block diagram of an output module as described herein for visualizing computing element importance ranking.

FIG. 7 is a computer-implemented method associated with the system of FIGS. 1A-1B for ranking computing elements in the context of cyber threat prioritization.

FIG. 8 is an exemplary simplified block diagram of a computing device that may be configured to implement various methodologies described herein.

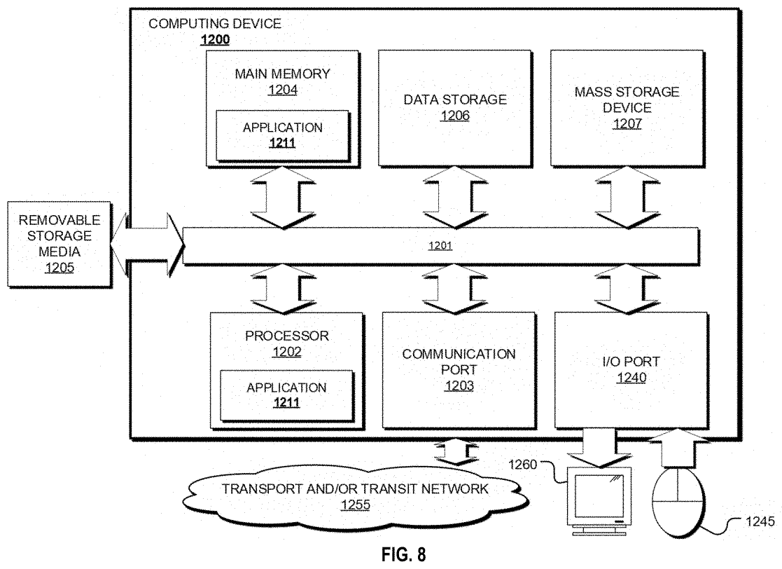

Corresponding reference characters indicate corresponding elements among the view of the drawings. The headings used in the figures do not limit the scope of the claims.

### DETAILED DESCRIPTION

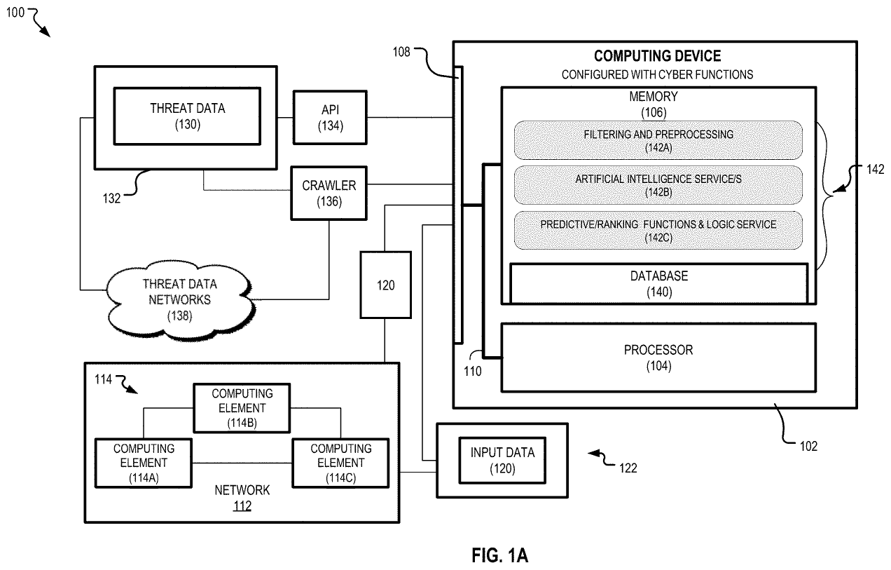

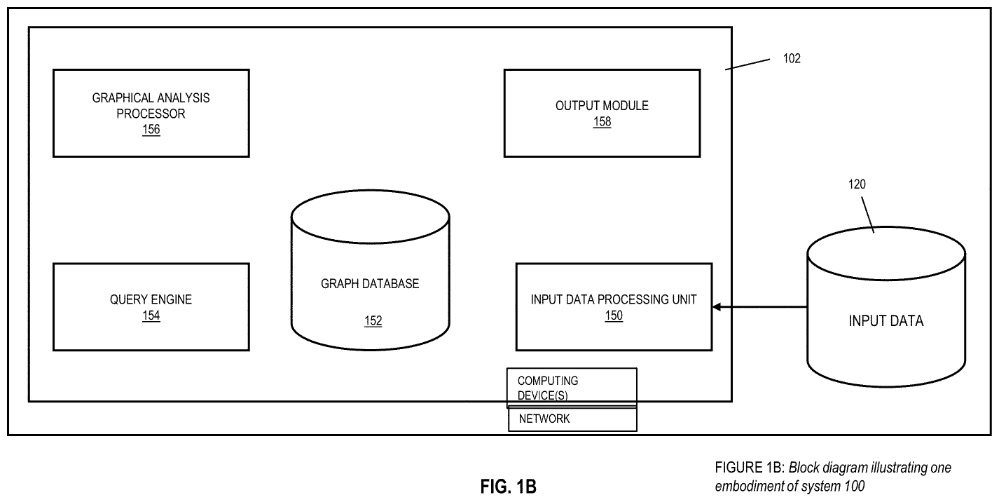

Aspects of the present disclosure relate to embodiments of a computer-implemented system (FIG. 1A) that takes as input data about a computer network including a plurality of computing elements such as computing devices or systems. The input data includes identifying information and/or may include information about interactions between and associated with the plurality of computing elements. Based on the input data, the present system is configured to create a multi-modal graphical structure representing the plurality of computing elements and their interactions. One or more queries and/or nodal measurements may be applied to data associated with the graphical structure to ultimately derive a ranking of the computing elements for improved cyber threat prioritization.

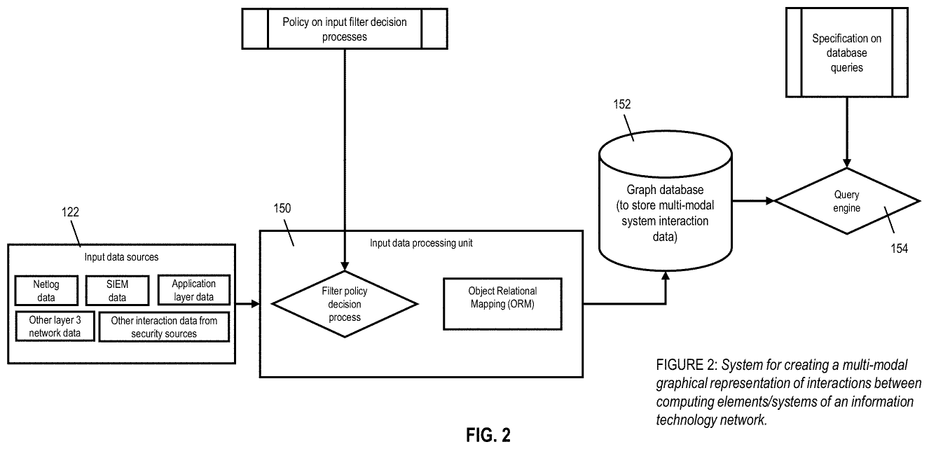

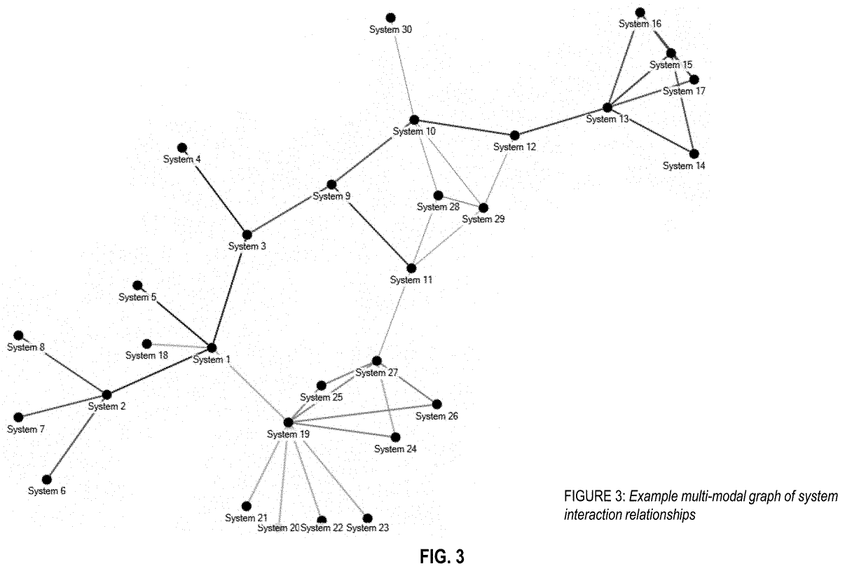

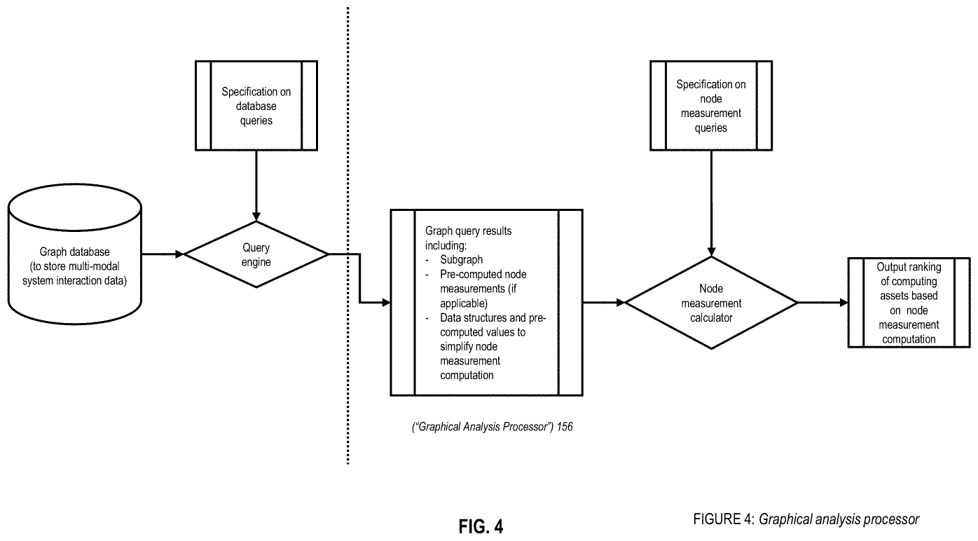

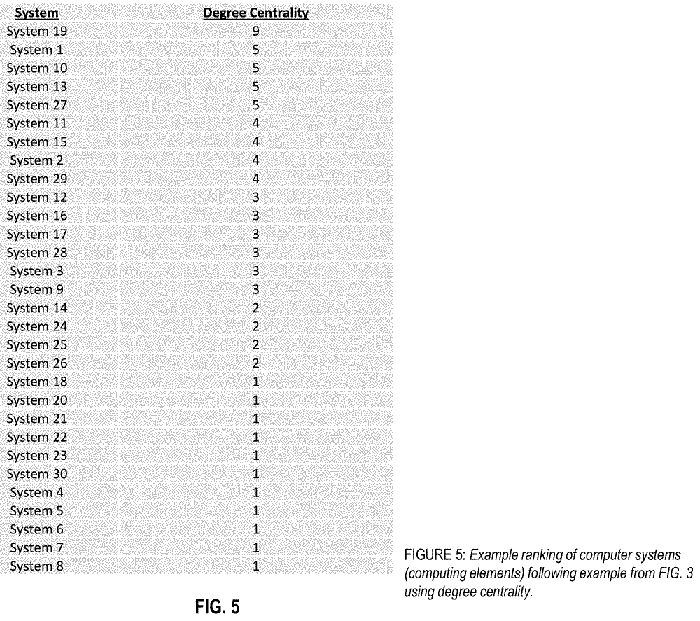

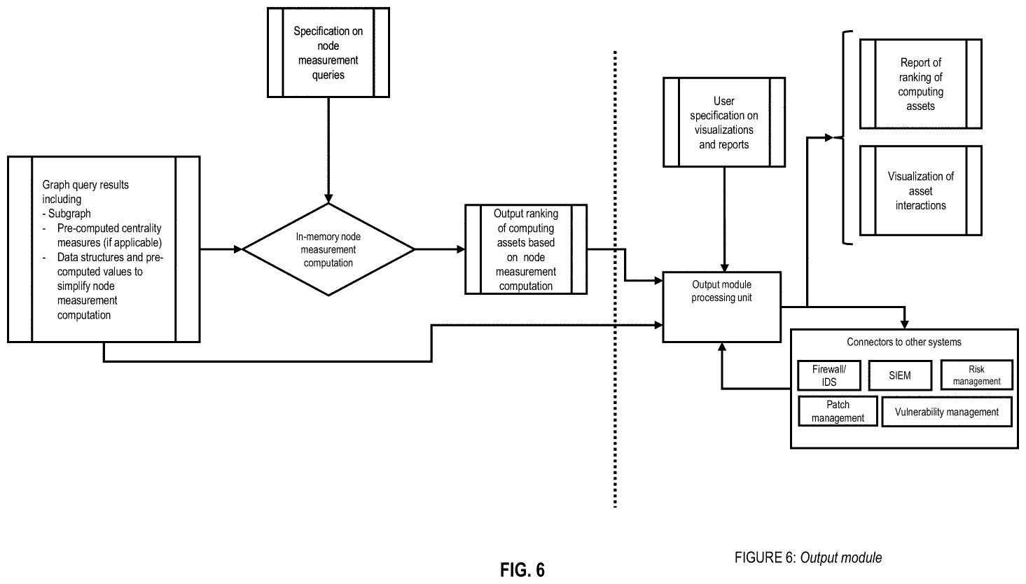

In some embodiments, the system includes an “Input Data Processing Unit”, “Graph database”, and “Query engine” which is shown in FIG. 1B and further depicted in FIG. 2, and an example from the system in the form of a multi-modal graph is shown in FIG. 3. This multi-modal graphical structure is then processed by a “Graphical analysis processor” of the system depicted in FIG. 4 which computes specified network nodal measures based on the graph; example output of the same being shown in FIG. 5. Finally, the results may be processed by an “output module” of the system which is depicted in FIG. 6 and includes report generation, visualization, and integration with other systems.

It should be appreciated that features of the present embodiments may be common to one or more other embodiments; i.e., features of the embodiments are not mutually exclusive, and different variations of the embodiments are contemplated.

### Introduction and Technical Challenges

### Definitions:

Network devices: A network device as referenced herein refers to one or more hardware devices or elements used to connect computing devices to a larger network and can include, by non-limiting examples, routers, switches, hubs, wireless access points, repeaters, modems, and the like.

Vulnerability: The term vulnerability as used herein may include a piece of software, hardware, or software/hardware combinations, that can be exploited by a hacking actor to perform unauthorized actions that are considered to be violating the confidentiality, integrity, or availability policies of a computing system hosting or executing the technology (software and/or hardware) having the vulnerability susceptible to exploit. Further, the term “vulnerability” can also be used to refer to a class of vulnerabilities and may not only include software flaws (may also include hardware or software/hardware combinations), but other flaws including but not limited to misconfigurations, to organizational practices, hardware, and physical security. It can also be used to describe a class of generalized computer issues that appeal to particular hackers or communities of hackers for purposes of compromising computer systems.

Vulnerability Exploitation: This term refers to an act of taking advantage of a software (and/or hardware) flaw within a computer system. Vulnerability exploitation is often performed using a piece of software, or a sequence of input data, known as an “exploit”.

Proof-Of-Concept (PoC) exploits: This term refers to non-malicious exploits that are developed only to demonstrate how hackers can take advantage of certain software (and/or hardware) flaws. Malicious hackers may leverage PoC exploits to craft weaponized, harmful exploits.

Hacking actors: This term refers to individuals who engage in activities related to software hacking, either with malicious (a.k.a., black-hat hackers) or non-malicious intent (a.k.a., white-hat hackers).

Online hacker communities: This term refers to online environments used by hackers around the globe, such as Chan sites, social media, paste sites, grey-hat communities, Tor, surface web, and even highly access-restricted sites.

Common Vulnerability and Exposure (CVE): This term refers to a unique identifier assigned to each software vulnerability in the National Vulnerability Database (NVD) maintained by the National Institute of Standards and Technology (NIST). The CVE numbering system associated with the NISD follows one of these two formats:

CVE-YYYY-NNNN; and

CVE-YYYY-NNNNNNN.

The “YYYY” portion of the identifier indicates the year in which the software flaw is reported, and the N′s portion is an integer that identifies a flaw (e.g., see CVE-2018-4917 related to https://nvd.nist.gov/vuln/detail/CVE-2018-4917, and CVE-2019-9896 related to https://nvd.nist.gov/vuln/detail/CVE-2019-9896).

Common Platform Enumeration (CPE): A Common Platform Enumeration, or CPE, relates to a list of software/hardware products that are vulnerable to a given CVE. The CVE and the respected platforms that are affected, i.e., CPE data, can be obtained from the NVD. For example, the following CPEs are some of the CPEs vulnerable to CVE-2018-4917:

cpe:2.3:a:adobe:acrobat_2017:*:*:*:*:*:*:*:*

cpe:2.3:a:adobe:acrobat_reader_dc:15.006.30033:*:*:*:classic:*:*

cpe:2.3:a:adobe:acrobat_reader_dc:15.006,30060:*:*:*:classic:*:*

Common vulnerability scoring system (CVSS): This term refers to a scoring system that captures the severity level of software vulnerabilities based on the technical characteristics such as the ease of exploitation and an approximation of impact it would leave if it is exploited. CVSS ranges from 0 to 10 (the most severe score). The CVSS base score is computed from the CVSS base vector, which is composed of two sub-scores, the Exploitability metrics and the Impact metrics. Each sub-score measures different technical characteristics related to the vulnerability. For example, the Exploitability metrics includes the Attack Vector metric, which explains how a vulnerability can be exploited. It can take one of the values: Network, Adjacent, Local, or Physical.

Multi-modal interaction graph (or simply “graph”): A graphical structure representing a set of entities (in this case, computer systems) and interactions of different types between them.

Node: Symbolic representation in a graph of computer systems.

Edge: A symbolic representation of an interaction between two nodes.

Path: A set of edges spanning two nodes that connects them.

Nodal measurement (or “node measurement”): A scalar value computed for a given node determined on the adjacent configuration of edges and edges of other nodes from which there is a path.

Graph database: A database in which a graph structure is stored.

Subgraph: A subset of a graph that includes certain nodes and edges from the full graph.

Technical Challenges: Information technology (IT) administrators lack sufficient technical means for efficiently identifying and practically addressing possible vulnerabilities of a technology configuration such as determining how to approach a given vulnerability (versus another). A given IT network or environment may be potentially susceptible to thousands of security vulnerabilities (at least those identifiable via the NVD). While the NVD and CVSS provide baseline information about some threats, there is insufficient technology presently available that might allow IT administrators to actually make sense of and intelligently leverage such information to apply responsive measures and prioritize patches or other fixes, and predict actual attacks based on the specifics of a given technology configuration.

In addition, it is technologically problematic and cumbersome to determine what elements of a network should be prioritized or otherwise deemed to be critical or important with respect to possible cyber threats. A given network may include thousands or more devices—many of which may be susceptible to cyber threats, yet, without sufficient technology it is problematic and technically challenging to rank or prioritize each of the devices. In short, security specialists simply cannot address all possible vulnerabilities, such that prioritization is needed.

### Computer-implemented System Responsive to Technical Challenges

Referring to FIG. 1A, an inventive concept responsive to the aforementioned technical challenges may take the form of a computer-implemented system, designated system 100, comprising any number of computing devices or processing elements. In general, the system 100 leverages artificial intelligence to implement cyber methods to e.g., provide automated ranking of computing elements of a target network using one or more multi-modal graphs. While the present inventive concept is described primarily as an implementation of the system, it should be appreciated that the inventive concept may also take the form of tangible, non-transitory, computer-readable media having instructions encoded thereon and executable by a processor, and any number of methods related to embodiments of the system described herein. In some embodiments, the system 100 comprises (at least one of) a computing device 102 including a processor 104, a memory 106 of the computing device 102 (or separately implemented), a network interface (or multiple network interfaces) 108, and a bus 110 (or wireless medium) for interconnecting the aforementioned components. The network interface 108 includes the mechanical, electrical, and signaling circuitry for communicating data over links (e.g., wires or wireless links) within a network (e.g., the Internet). The network interface 108 may be configured to transmit and/or receive data using a variety of different communication protocols, as will be understood by those skilled in the art.

As further described herein, the computing device 102 is adapted to access information about a (target) network 112 associated with a plurality of computing elements 114, designated, by non-limiting examples, computing element 114A, computing element 114B, and computing element 114C. The plurality of computing elements 114 or assets may include, without limitation, physical devices such as a desktop computer, server, mainframe, laptop, tablet, or any mobile device such as a smartphone. The plurality of computing elements 114 may further include systems of devices, virtualized devices, or combinations of virtual and physical devices associated with the network 112.

In general, via the network interface 108 or otherwise, the computing device 102 is adapted to access input data 120 from one or more sources 122 that is helpful for ranking the plurality of computing elements 114, and the input data 120 may be generally stored/aggregated within a storage device (not shown) or locally stored within the memory 106 for further processing. The input data 120 may include, without limitation, information about interactions between the plurality of computing elements 114, information specific to each of the plurality of computing elements 114 (e.g., specific configuration, type, identifier, etc.), and the like. As indicated in FIG. 1A, the input data 120 may be accessed by the computing device 102 directly from the network 112 or from one or more of the plurality of computing elements 114, and/or the input data may be accessed by an intermediate device or host service, or may be extracted from any number of data sources 122. The input data 120 may further be accessed voluntarily, i.e., the input data 120 may be provided to the computing device 102, or the input data 120 may be accessed using a crawler 128, spider, or any other such methods.

In addition, the computing device 102 is adapted to access threat data 130 from any number of devices 132, systems, or networks. The threat data 130 includes any information about hacker communications, information about cybersecurity events across multiple technology platforms referenced herein, information about known vulnerabilities associated with hardware and software components, any information from the NVD including updates, and the like. As shown, the computing device 102 may further be adapted to access the threat data 130 directly and/or indirectly from various sources, such that the devices 132 may be associated with the deep or dark web (D2web), or the general Internet including hacking actors, hacking communities, or any sources of information related to hacking). In some embodiments, the computing device 102 accesses the threat data 130 by engaging an application programming interface 134 to establish a temporary communication link with the device 132. Alternatively, or in combination, the computing device 102 may be configured to implement a crawler 136 (or spider or the like) to extract the threat data 130 from the devices 132. Further, the computing device 102 may access the threat data 130 from any number or type of devices associated with any number of threat data networks 138, e.g., the general Internet or World Wide Web, deep/dark web, as needed, with or without aid from a specific device.

In general, the threat data 130 may be leveraged by the computing device 130 to generate mappings between platform enumerations and vulnerabilities associated with such platform enumerations. For example, leveraging the threat data 130, the computing device 102 generates a database that links a particular piece of software or hardware device to a known vulnerability as discovered via the NISD, or otherwise discovered. Possible exploits may be linked to the same piece of software or hardware device. In this manner, the threat data 130 is informative as to what kinds of software and/or hardware configurations are susceptible to possible vulnerabilities and exploits thereof.

The input data 120 and the threat data 130 accessed may generally define or be organized into datasets or any predetermined data structures which may be aggregated or accessed by the computing device 102 and may be organized within a database 140 stored in the memory 106 or otherwise stored. Once this data is accessed and/or stored in the database 140, the processor 104 is operable to execute a plurality of services 142, encoded as instructions within the memory 106 and executable by the processor 104, to process the data so as to determine correlations and generate rules or predictive functions, as further described herein. The services 142 of the system 100 may generally include, without limitation, a filtering and preprocessing service 142A for, in general preparing the input data 120 and/or threat data 130 for machine learning or further use; an artificial service 142B comprising any number or type of artificial intelligence functions for modeling information (e.g., natural language processing, classification, neural networks, linear regression, etc.) and/or feature extraction and any other related methods; and a predictive/ranking functions/logic service 142C that formulates ranking or predictive cyber functions and outputs, and view of the input data 120, one or more values suitable for reducing risk or ranking the computing elements 114. The plurality of services 142 may include any number of components or modules executed by the processor 104 or otherwise implemented. Accordingly, in some embodiments, one or more of the plurality of services 142 may be implemented as code and/or machine-executable instructions executable by the processor 104 that may represent one or more of a procedure, a function, a subprogram, a program, a routine, a subroutine, a module, an object, a software package, a class, or any combination of instructions, data structures, or program statements, and the like. In other words, one or more of the plurality of services 142 described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 106), and the processor 104 performs the tasks defined by the code.

Multi-modal graphical representation

Referring to FIG. 1B, as indicated, embodiments of the system 100 including the computing device 102 (and/or processor 104) are configured to implement an input data processing unit 150, a graph database 152, and a query engine 154. These components may be embodied in software, hardware, and/or combinations thereof and relationships between these components are shown in FIG. 1B and further detailed in FIG. 2. In general, the computing device 102 leverages the input data processing unit 150 to access the input data 120 from one or more of the data sources 122 and/or directly from the computing elements 114 or the network 112. The input data 120 includes information about on or more of the plurality of computing elements 114 of the network 112 and may also include information about interactions between one or more of the plurality of computing elements 114. As previously described, the plurality of computing elements 114 can include physical systems (at the infrastructure level), virtualized devices/systems, or combinations thereof. In principle, each of the plurality of computing elements 114 is identified by a unique address which may be a layer 3 (ref. OSI model) address such as an Internet Protocol (IP) address, a layer 2 (ref. OSI model) address such as a MAC address, or other unique identifier (e.g., host name). This identifying information may be accessed and may be included within the input data 120.

As further described, the input data 120 may include information about the interactions among the computing elements 114. This can be based on layer 3 level traffic between the plurality of computing elements 114 (i.e., IP packets sent between two computer devices in the network 112), application layer information (i.e., HTTP requests), or higher-level information (i.e., Application Programming Interface (API) requests). The interactions among the plurality of computing elements 114 can be specified in a variety of possible formats, but at a minimum it contains information about the one or more of the computing elements 114 that have communicated with each other and ideally information concerning when the communication took place, the direction of the communication, the volume of the communication over a unit of time, applications involved, various pieces of metadata (i.e. header information), and even derived data (i.e. if the interaction is suspected to be malicious). As depicted in FIG. 2, there are multiple possible data sources 122 which may be leveraged to access the input data 120 which may include, but are not limited to the following examples:

Network log data such as NETFLOW

System log data

Security Information and Event Management (SIEM) data

Logs from various applications

Data from various security tools such as packet sniffers or deep packet inspection

As the input data 120 is collected via the input data processing unit 150, the various interactions between the plurality of computing elements 114 may be filtered based on predetermined criteria specified by the user (“Policy on input filter decision process” of FIG. 2) which determines items like the acceptable criteria by which to consider an interaction as important, limiting the time period of which interactions can be considered, limiting considered interactions to those of certain types, etc. This criteria can be specified by the user, but can also be created through automated means (e.g., machine learning) or rely on default settings derived from best practices.

In some embodiments, interactions that meet the specified criteria are inputted into the graph database 152 by means of object relational mapping (ORM) which will map the resulting interaction to the graph database 152. The graph database 152 may be embodied in multiple ways. For example, the database may be designed to store graphical interactions (i.e. Neoj, Giraph, System G, etc.); may comprise a SQL database with relationship tables and optimizations for interactions (i.e. Postgres, Oracle, etc.); or may take the form of a document-based storage system (i.e. MongoDB). In either variation, the system 100 is configured in a suitable manner to store interactions and their associated metadata.

An example of a resulting graphical interaction structure is shown in FIG. 3. In this sample graph, interactions between systems in a computer network is shown visually with different colored relationship edges specifying various types of relationships among systems (network protocol, application or transport layer communication, API connection, etc.). In a different embodiment, directions and weights of the edges may be included, as well as temporal dimensions.

In addition, the system 100 may include the query engine 154 implemented by the computing device 102 or separately implemented. The query engine 154 is designed to support queries that lead to the calculation of nodal measurements (performed by the system 100 as described herein). These queries may include the ability to induce subgraphs based on the graphical structure (thereby limiting the size of the graph for a nodal measurement to be computed), metrics to be pre-computed to ease the computation or re-computation of nodal measures, or in some cases the computation of nodal measures themselves. The queries to be calculated, and how they will be calculated may also be specified by the “Specification on database queries” in FIG. 2 which may be user-defined and likely defined by the user at the time related settings are emplaced in the system 100. Settings may include specification of subgraphs and specification of what pre-computed values or nodal measures will facilitate the computations of the system 100.

The output from the embodiment of the system 100 in FIG. 1B, which may be further processed and/or leveraged as described herein, includes a subgraph from which node measurements may be computed, pre-computed node measurements, and data structures or other pre-computed values to simplify node measurement computation. This is depicted in FIG. 4 (“Graph query results”).

Graphical-driven ranking

As further shown in FIG. 1 B, the computing device 102 and/or the system 100 may further include or be configured to implement a graphical analysis processor 156, detailed in FIG. 4. The graphical analysis processor 156 accepts as input the “Graph query results” described above and depicted in FIG. 4. From these results, nodal measurements may be computed using a “Node measurement calculator” which utilizes one or a combination of standard nodal measurements which are specified by the user based on best-practices or previously learned parameters (“Specification on node measurement queries” in FIG. 4). Further, different embodiments may use different nodal measurements. Software such as SNAP or NetworkX can be used to compute the nodal measurements which can be computed based on the resulting subgraph described herein as well as considering certain parameters. Such nodal measurements may include, but are not limited by the following.

Degree-based metric: Given a graph constructed as described herein (FIG. 3), importance of a given one of the plurality of computing elements 114 can be computed using degree centrality, whereby counting the number of other elements and/or systems it interacts with. This can be further weighted or adjusted by the strength, type, and/or direction of the interactions. For the classical definition, see MacDonald et al., 2012 (section 3).

Betweenness-based metric: This can be calculated as a function of the number of paths in the graph that contain the node. Again, this can be adjusted not only based on criteria of the paths (i.e. the path length, only the shortest paths, etc.) but also adjusted based on weight of interactions, edge type, direction, etc. For the classical definition, see MacDonald et al., 2012 (section 3).

Closeness Centrality-based metric: This can be calculated as a function of the number of paths emanating from the node—again with the variations as described above. For the classical definition, see MacDonald et al., 2012 (section 3).

PageRank-based metric: As per section 3.6 of MacDonald et al., 2012 (and the references within)—adjusted per the notes in the above measurements.

Eigenvector Centrality-based metric: As per section 3.5 of MacDonald et al., 2012 (and the references within)—adjusted per the notes in the above measurements.

K-Shell Decomposition metric: As per section 3.2 of MacDonald et al., 2012 (and the references within)—adjusted per the notes in the above measurements.

Metric based on logical rules: As per the methodology described in Shakarian et al. (2013) and the papers cited within.

Combinatorial based measurements: As per the combinatorial measurements specified in works such as Moores et al. (2014) and the papers cited within—also considering the modifications of the other measurements.

Ultimately, the output is a ranking of the computing elements 114 based on node measurement computations, as indicated in FIG. 4. On exemplary non-limiting example of output from the system 100 is depicted in FIG. 5. In the sample shown, the importance of computing elements is computed using the multi-modal graph of FIG. 3 along with degree centrality. In a different embodiment, other node measurement computations may be used (e.g., PageRank, k-shell decomposition, Closeness Centrality, etc.) and these measurements may also consider various factors of the multi-modal edges (i.e., when in time the edge existed, what protocol it was based on, the weight of the edge, etc.).

In an embodiment of this system 100 that would produce such sample output, the nodal measurement used was degree centrality and clearly identifies important ones of the plurality of computing elements 114 based on that measurement.

### Providing Analytical Results and Workflow Support

In some embodiments, the system 100 includes the output module 158 shown in FIG. 1B and further detailed in FIG. 6 implemented by the computing device 102 or otherwise implemented. This module can accept the output from the graphical representation and ranking described herein in order to produce visualizations and reports suitable for use in an operational environment. FIG. 3 and FIG. 5 can be considered examples of such output as well. Further, the “output processing module” (FIG. 6) would also accept additional information from other sources (see “Connectors to other systems”) to augment the output in such reports or visualizations. Additionally, information can also be output to such systems through the Connectors in order to be viewed or explored in those systems. This module will consider various settings from the user via the “User specification on visualization and reports” when creating such output. Such user parameters can specify the portion of the results suitable to display, the format of the report (PDF, JPEG, PowerPoint, etc.) and other cosmetic aspects.

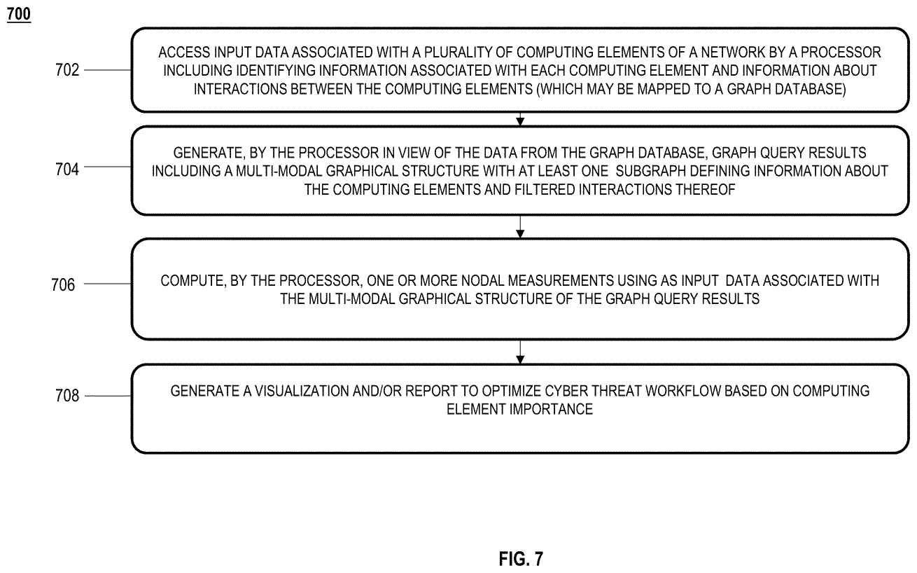

FIG. 7 depicts an exemplary method 700 associated with the system 100. In block 702, the computing device 102 accesses (by an input data processing unit or otherwise) the input data 120 associated with the plurality of computing elements 114 including identifying information and information about interactions between the plurality of computing elements. At least a portion of the interactions and associated metadata from the input data into a database (e.g., graph database 152). The interactions may be filtered based upon predetermined criteria.

Referring to block 704, the computing device 102 generates a graphical structure of the interactions, the graphical structure being multi-modal and including nodes representing the plurality of computing elements and edges visualizing predetermined interactions between the plurality of computing elements, the graphical structure providing improved cyber threat prioritization. In some embodiments, the query engine 154 is implemented at this stage and supports queries leading to graph query results and that further induces one or more subgraphs from the graphical structure.

Referring to block 706, a node measurement calculator of a graphical analysis processor implemented by the computing device 102 applies one or more nodal measurements to the graph query results or information associated with the graphical structure to output a ranking of the plurality of computing elements. As indicated in block 707, the rankings and graphical structure may be embodied within a report or visualization as desired.

### Exemplary Computing Device

Referring to FIG. 7, a computing device 1200 is illustrated which may take the place of the computing device 102 and be configured, via one or more of an application 1211 or computer-executable instructions, to execute functionality described herein. More particularly, in some embodiments, aspects of the predictive and/or ranking methods herein may be translated to software or machine-level code, which may be installed to and/or executed by the computing device 1200 such that the computing device 1200 is configured to execute functionality described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

what is claimed is:

1. A system for automated computer asset importance ranking, comprising:
a network interface that provides access to data associated with a plurality of networks; and
a computing device in operable communication with the network interface, the computing device configured to:
access input data about a plurality of computing elements of a network, the input data including identifying information and interaction information defining interactions between the plurality of computing elements,
map at least a portion of the interactions and associated metadata from the input data into a database, and
generate a graphical structure from the interactions as mapped to the database, the graphical structure being multi-modal and including nodes representing the plurality of computing elements and edges visualizing predetermined interactions between the plurality of computing elements, the graphical structure providing improved cyber threat prioritization.

2. The system of claim 1, wherein the computing device further comprises:
a node measurement calculator of a graphical analysis processor that applies one or more nodal measurements to the graph query results to output a ranking of the plurality of computing elements.

3. The system of claim 1, wherein the computing device further comprises:
an input data processing unit that extracts the input data via the network interface and filters the interactions based upon a predetermined criteria; and
a query engine that supports queries leading to graph query results and that further induces one or more subgraphs from the graphical structure.

4. The system of claim 1, wherein the database is a graph database that stores the interaction information associated with the plurality of computing elements by object relational mapping applied to the input data by the computing device.

5. The system of claim 1, wherein the identifying information includes a unique identifier associated with each of the plurality of computing elements.

6. The system of claim 5, wherein the unique identifier includes a MAC address or an IP address.

7. The system of claim 1, wherein the interaction information includes information associated with a communication between at least two of the plurality of computing elements.

8. The system of claim 7, wherein the communication defines a direction, a volume over time, and software invoked by the communication between the at least two of the plurality of computing elements.

9. A method of prioritizing cyber threat response via graphical computing asset importance ranking, comprising:
accessing, by an input data processing unit of a computing device, input data associated with a plurality of computing elements including interactions between the plurality of computing elements;
inputting at least a portion of the interactions and associated metadata from the input data into a database; and
generating by the computing device a graphical structure of the interactions, the graphical structure being multi-modal and including nodes representing the plurality of computing elements and edges visualizing predetermined interactions between the plurality of computing elements, the graphical structure providing improved cyber threat prioritization.

10. The method of claim 9, further comprising applying by the computing device one or more nodal measurements to data associated with the graphical structure to output a ranking of importance for the plurality of computing elements for improved cyber threat prioritization.

11. The method of claim 9, further comprising automatically filtering interactions based upon a predetermined criteria.

12. The method of claim 11, further comprising inputting into a graph database interactions from the input data that meet the predetermined criteria via object relational mapping.

13. A tangible, non-transitory, computer-readable media having instructions encoded thereon, the instructions, when executed by a processor, being operable to:
access input data associated with a plurality of computing elements including interactions between the plurality of computing elements;
input at least a portion of the interactions and associated metadata from the input data into a database; and
generate a graphical structure of the interactions, the graphical structure being multi-modal and including nodes representing the plurality of computing elements and edges visualizing predetermined interactions between the plurality of computing elements, the graphical structure providing improved cyber threat prioritization.

14. The tangible, non-transitory, computer-readable media of claim 13, wherein the instructions, when executed by the processor, are further operable to:
apply one or more nodal measurements to data associated with the graphical structure to output a ranking of importance for the plurality of computing elements for improved cyber threat prioritization.
